(19) United States
(12) Patent Application Publication
(10) Pub. No.: US 2009/0257844 A1
(43) Pub. Date: Oct. 15, 2009

(54) Recessed head screw

(75) Inventors: Kuan-Ying Chou, Kaohsiung City (TW); Chun-Yen Chen, Kaohsiung City (TW)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Sheh Fung Screws Co., Ltd.

(21) Appl. No.: 12/287,780

(22) Filed: Oct. 14, 2008

(30) Foreign Application Priority Data
Apr. 11, 2008 (TW) 097206216

(51) Int. Cl. F16B 23/00

(52) U.S. Cl. 411/410

(57) ABSTRACT

A recessed head screw includes a head portion having a driver-engaging part between top and bottom faces thereof. The driver-engaging part includes a recess extending downwardly from the top face, four spaced-apart slanting walls slanting downwardly and convergingly from the top face, and four first bearing pieces each spacing two adjacent ones of the slanting walls and each having a four-sided first bearing face, and two substantially triangular second faces interconnected by the first bearing face. At least two second bearing pieces extend downwardly and respectively from bottoms of two opposite first bearing pieces. Each second bearing piece has a connecting face, and a third bearing face extending downwardly and inwardly from the connecting face. The connecting face inclines with respect to both of the third bearing face and the respective first bearing face.

### CROSS-REFERENCE TO RELATED APPLICATION

This application claims priority of Taiwanese Application No. 097206216, filed on Apr. 11, 2008.

### BACKGROUND OF THE INVENTION

1. Field of the Invention

This invention relates to a screw, more particularly to a recessed head screw.

2. Description of the Related Art

Referring to FIG. 1, a conventional recessed head screw 100, as disclosed in U.S. Pat. No. 6,786,827, includes a head portion 1 having a top face 11, and a driver-engaging part 12 extending inwardly from the top face 11 for engagement with a screwdriver so that the screwdriver can drive the screw 100 to rotate. The driver-engaging part 12 has four spaced-apart slanting walls 121 (only three are shown) each extending downwardly and convergingly from the top face 11, four protrusions 122 (only two are shown) each disposed between two adjacent ones of the slanting walls 121, and a bottom face 123 tapering downwardly from bottoms of the slanting walls 121 and the protrusions 122. Each protrusion 122 has a first planar face 124, and two second planar faces 125 extending respectively from two opposite sides of the first planar face 124 to the respective slanting walls 121.

Hence, the driver-engaging part 12 can engage with a slotted, crosshead, square drive, or Pozidriv screwdriver. When a square drive screwdriver (not shown) is used with the recessed head screw 100, each driving face of the screwdriver abuts against the respective first planar face 124, so that a rotating torque of the screwdriver is transferred to the first planar faces 124 to thereby rotate the screw 100. When a crosshead screwdriver (not shown) is used with the recessed head screw 100, the tip of the screwdriver abuts against the bottom face 123 of the driver-engaging part 12, and each driving face of the screwdriver abuts against the respective second planar face 125, so that a rotating torque of the screwdriver is transferred to the second planar faces 125 to thereby rotate the screw 100.

However, when a Pozidriv screwdriver (not shown) is used with the recessed head screw 100, since the driving faces of the Pozidriv screwdriver are long and tapered, the depth of the driver-engaging part 12 is insufficient. As a result, when the Pozidriv screwdriver is engaged with the driver-engaging part 12, while the tip end portion of the Pozidriv screwdriver abuts against the bottom face 123, the driving faces thereof cannot completely extend into the driver-engaging part 12 so as to abut respectively against the second planar faces 125 of the protrusions 122. Hence, the conventional recessed head screw 100 cannot be driven by a Pozidriv screwdriver to rotate.

### SUMMARY OF THE INVENTION

Therefore, the object of the present invention is to provide a recessed head screw that can engage with various types of screwdrivers.

According to this invention, a recessed head screw comprises a head portion and a shank portion. The head portion has a top face, a bottom face, and a driver-engaging part between the top and bottom faces. The shank portion extends downwardly from the bottom face of the head portion, and has a thread formed on an outer surface thereof. The driver-engaging part includes a recess extending downwardly from the top face, four spaced-apart slanting walls bounding the recess and slanting downwardly and convergingly from the top face, four first bearing pieces bounding the recess and each spacing two adjacent ones of the slanting walls, at least two second bearing pieces bounding the recess and extending downwardly and respectively from bottoms of two opposite ones of the first bearing pieces, and a cone-shaped bottom face bounding the recess and extending downwardly from bottoms of the slanting walls and bottoms of the second bearing pieces. Each of the first bearing pieces has a four-sided first bearing face extending downwardly from the top face, and two substantially triangular second faces extending downwardly from the top face and interconnected by the first bearing face. Each of the second faces is connected between the first bearing face and one of the slanting walls. Each of the second bearing pieces has a connecting face extending downwardly and inwardly from a respective one of the first bearing faces, a third bearing face extending downwardly and inwardly from the connecting face, and two fourth bearing faces each of which is connected between the third bearing face and one of the slanting walls. The connecting face inclines with respect to both of the third bearing face and the respective first bearing face.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary sectional view of a conventional recessed head screw;

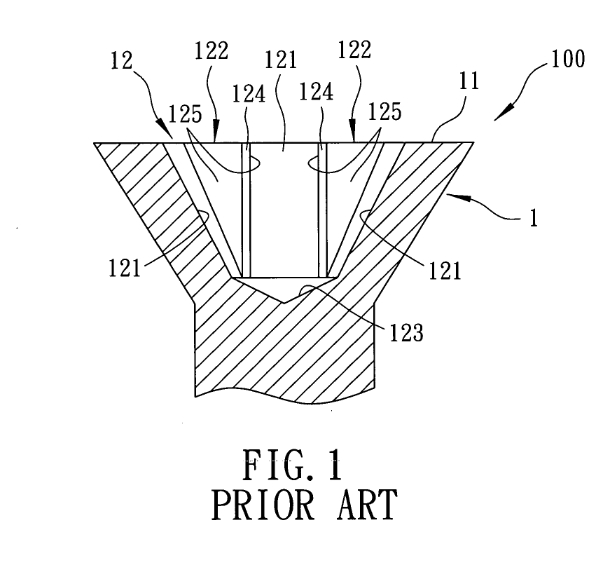

FIG. 2 is a perspective view of a recessed head screw according to the preferred embodiment of the present invention;

FIG. 3 is a schematic top view of the preferred embodiment; and

FIG. 4 is a fragmentary sectional view of the preferred embodiment.

### DETAILED DESCRIPTION OF THE PREFERRED EMBODIMENT

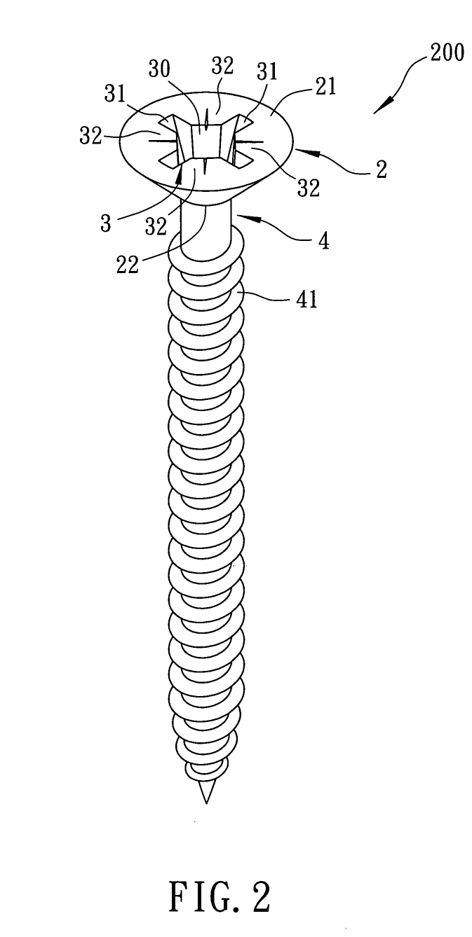

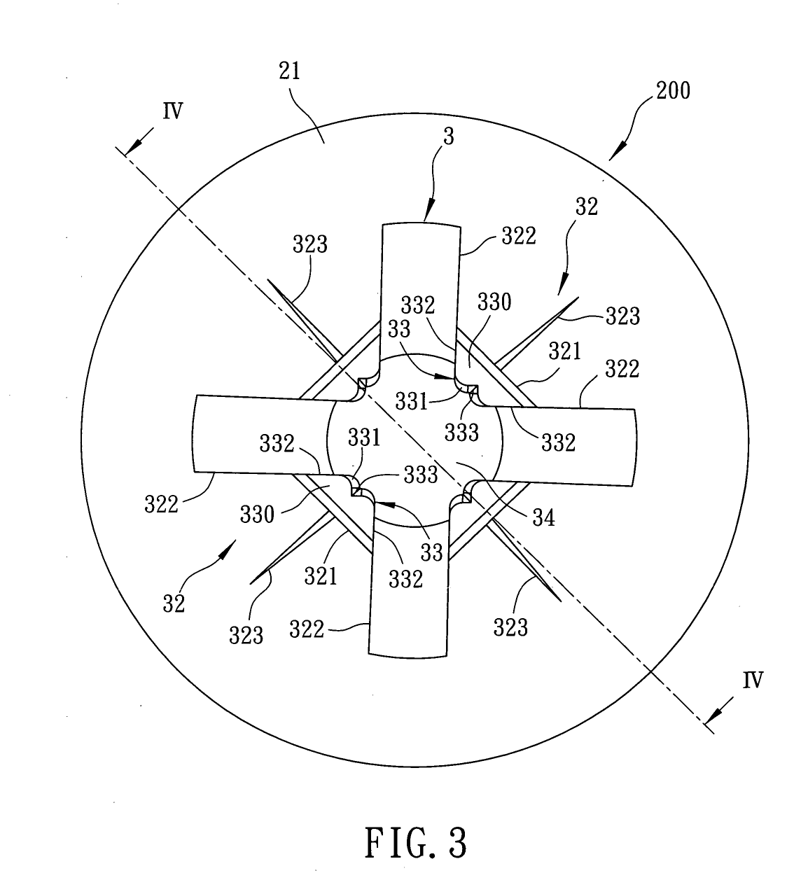

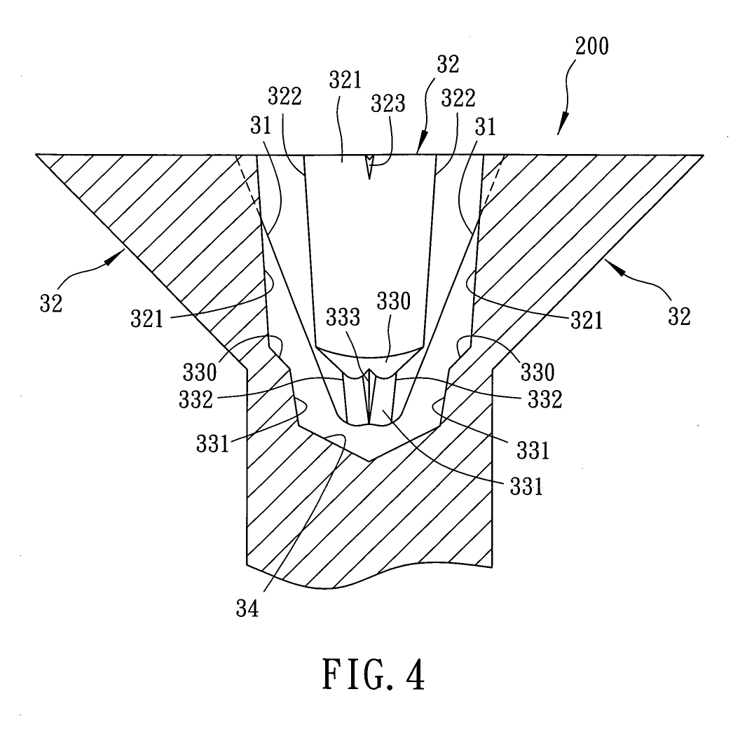

Referring to FIGS. 2 to 4, a recessed head screw 200 according to the preferred embodiment of the present invention is shown to comprise a head portion 2 and a shank portion 4.

The head portion 2 has a top face 21, a bottom face 22, and a driver-engaging part 3 disposed between the top and bottom faces 21, 22.

The shank portion 4 extends downwardly from the bottom face 22 of the head portion 2, and has a thread 41 formed on an outer surface thereof.

The driver-engaging part 3 of the head portion 2 includes a recess 30, four spaced-apart slanting walls 31 (only two are visible in FIG. 2), four first bearing pieces 32, four second bearing pieces 33, and a cone-shaped bottom face 34. The recess 30 extends downwardly from the top face 21. The slanting walls 31 bound the recess 30, and slant downwardly and convergingly from the top face 21. Each two, non-adjacent slanting walls 31 are opposite to each other. The first bearing pieces 32 bound the recess 30, and each of the first bearing pieces 32 spaces two adjacent ones of the slanting walls 31. Each first bearing piece 32 has a four-sided first bearing face 321 extending downwardly from the top face 21, and two substantially triangular second faces 322 extending downwardly from the top face 21 and interconnected by the first bearing face 321. Each of the second faces 322 is connected between the first bearing face 321 and one of the slanting walls 31. Four angularly spaced-apart depressions 323 are formed in the top face 21 of the head portion 2, and extend radially, outwardly, and respectively from the first bearing faces 321.

The second bearing pieces 33 bound the recess 30, and extend downwardly and respectively from bottoms of the first bearing pieces 32. Each of the second bearing pieces 33 has a connecting face 330 extending downwardly and inwardly from a respective one of said first bearing faces 321, a third bearing face 331 extending downwardly and inwardly from the connecting face 330, and two fourth bearing faces 332 each of which is connected between the third bearing face 331 and one of the slanting walls 31. The connecting face 330 inclines with respect to both of the third bearing face 331 and the respective first bearing face 321. The third bearing face 331 of each of the second bearing pieces 33 has a flute 333 that tapers downwardly.

The cone-shaped bottom face 34 bounds the recess 30, and extends downwardly from bottoms of the slanting walls 31 and bottoms of the second bearing pieces 33.

When a crosshead or a Pozidriv screwdriver (not shown) is inserted into the recess 30 so as to engage the driver-engaging part 3 of the recessed head screw 200, driving faces of the screwdriver abut respectively against the second faces 322 and the fourth bearing faces 332. As the screwdriver is rotated, torque is applied to rotate the recessed head screw 200. The tip end of the screwdriver abuts against the cone-shaped bottom face 34 at this time.

Further, the flutes 333 in the third bearing faces 331 of the second bearing pieces 33 are used to match reinforcing ribs formed on the Pozidriv screwdriver. When the Pozidriv screwdriver is inserted into the recess 30 in the driver-engaging part 3, the reinforcing ribs of the Pozidriv screwdriver extend into and abut against the respective flutes 333 to assist in transmission of torque so as to rotate the recessed head screw 200.

Moreover, when a slotted screwdriver (not shown) is inserted into the recess 30 in the driver-engaging part 3, a slotted tip of the screwdriver abuts against two opposite slanting walls 31, and driving faces of the screwdriver abut against the corresponding second faces 322 so as to push the same for transmission of torque, thereby driving the recessed head screw 200 to rotate.

Advantages of the present invention may be summarized as follows:

1. Because the driver-engaging part 3 is deep, it can be used effectively with a Pozidriv screwdriver. In particular, through an additional space confined by the slanting walls 31 and the second bearing pieces 33, the depth of the driver-engaging part 3 is enhanced, so that when the Pozidriv screwdriver is inserted into the recess 30, the tip end thereof can abut against the bottom face 34, and the driving faces thereof can extend sufficiently into the driver-engaging part 3 and abut respectively against the second and fourth bearing faces 322, 332 of the screw 200. Since contact areas between the Pozidriv screwdriver and the screw 200 are increased, transmission of torque can be effectively enhanced. Further, the problems associated in using a Pozidriv screwdriver with the conventional recessed head screw 100 are resolved.

2. The recessed head screw 200 of the present invention can be used with various types of screwdrivers, such as slotted, crosshead, square drive, and Pozidriv screwdrivers. Hence, the recessed head screw 200 allows for flexibility and convenience in use.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A recessed head screw comprising:
a head portion having a top face, a bottom face, and a driver-engaging part between said top and bottom faces; and
a shank portion extending downwardly from said bottom face of said head portion and having a thread formed on an outer surface thereof;
said driver-engaging part including
a recess extending downwardly from said top face;
four spaced-apart slanting walls bounding said recess and slanting downwardly and convergingly from said top face;
four first bearing pieces bounding said recess and each spacing two adjacent ones of said slanting walls, each of said first bearing pieces having a four-sided first bearing face extending downwardly from said top face, and two substantially triangular second faces extending downwardly from said top face and interconnected by said first bearing face, each of said second faces being connected between said first bearing face and one of said slanting walls;
at least two second bearing pieces bounding said recess and extending downwardly and respectively from bottoms of two opposite ones of said first bearing pieces, each of said second bearing pieces having a connecting face extending downwardly and inwardly from a respective one of said first bearing faces, a third bearing face extending downwardly and inwardly from said connecting face, and two fourth bearing faces each of which is connected between said third bearing face and one of said slanting walls, said connecting face inclining with respect to both of said third bearing face and said one of said first bearing faces; and
a cone-shaped bottom face bounding said recess and extending downwardly from bottoms of said slanting walls and bottoms of said second bearing pieces.

2. The recessed head screw of claim 1, wherein said third bearing face of each of said second bearing pieces has a flute that tapers downwardly.

3. The recessed head screw of claim 2, wherein said driver-engaging part further includes four angularly spaced-apart depressions formed in said top face of said head portion and extending radially, outwardly, and respectively from said first bearing faces.
